(19) United States
(12) Patent Application Publication
(10) Pub. No.: US 2010/0156310 A1
(43) Pub. Date: Jun. 24, 2010

(54) LOW FREQUENCY ELECTRODELESS PLASMA LAMP

(75) Inventors: Gregg Hollingsworth, Tempe, AZ (US); Marc DeVincentis, Palo Alto, CA (US); Sandeep Mudunuri, Sunnyvale, CA (US)

Correspondence Address: SCHWEGMAN, LUNDBERG & WOESSNER, P.A., P.O. BOX 2938, MINNEAPOLIS, MN, 55402, US

(73) Assignee: Luxim Corporation, Sunnyvale, CA (US)

(21) Appl. No.: 12/562,763

(22) Filed: Sep. 18, 2009

Related U.S. Application Data
(60) Provisional application No. 61/098,201, filed on Sep. 18, 2008.

(51) Int. Cl. H05B 41/24

(52) U.S. Cl. 315/248

(57) ABSTRACT

An electrodeless plasma lamp and a method of generating light are provided. The plasma lamp may comprise a power source to provide radio frequency (RF) power, and a bulb containing a fill that forms a plasma when the RF power is coupled to the fill. The plasma lamp further comprises a resonant structure having a quarter wave resonant mode. The resonant structure includes a lamp body comprising a dielectric material having a relative permittivity greater than 2, an inner conductor, and an outer conductor. The power source is configured to provide the RF power to the lamp body at about a resonant frequency for the resonant structure.

### RELATED APPLICATION

This application claims priority to U.S. Provisional Patent Application Ser. No. 61/098,201 entitled LOW FREQUENCY ELECTRODELESS PLASMA LAMP, filed Sep. 18, 2008, the entire contents of which is incorporated herein by reference.

### BACKGROUND

The field relates to systems and methods for generating light, and more particularly to electrodeless plasma lamps.

### BRIEF DESCRIPTION OF THE DRAWINGS

FIG. 1A is a cross-section and schematic view of a plasma lamp according to an example embodiment.

FIG. 1B is a perspective cross section view of a lamp body with a cylindrical outer surface according to an example embodiment.

FIG. 2A is a side cross section of a bulb according to an example embodiment.

FIG. 2B is a side cross section of a bulb with a tail according to an example embodiment.

FIG. 2C illustrates a graph of the spectrum produced by a fill according to an example embodiment.

FIG. 3A is a block diagram of a drive circuit for an electrodeless plasma lamp according to an example embodiment.

FIG. 3B is a block diagram of an RF power detector according to an example embodiment.

FIG. 3C is a block diagram of an RF power detector according to an alternative example embodiment.

FIGS. 4A-E are flow charts of a method for starting an electrodeless plasma lamp according to an example embodiment.

FIG. 5 is a flow chart of a method used for run mode operation of an electrodeless plasma lamp according to an example embodiment.

FIGS. 6A-D show example embodiments using a tuning hole in the lamp body for impedance matching and/or frequency tuning.

### DETAILED DESCRIPTION OF EXAMPLE EMBODIMENTS

While the present invention is open to various modifications and alternative constructions, the embodiments shown in the drawings will be described herein in detail. It is to be understood, however, there is no intention to limit the invention to the particular forms disclosed. On the contrary, it is intended that the invention cover all modifications, equivalences and alternative constructions falling within the spirit and scope of the invention as expressed in the appended claims.

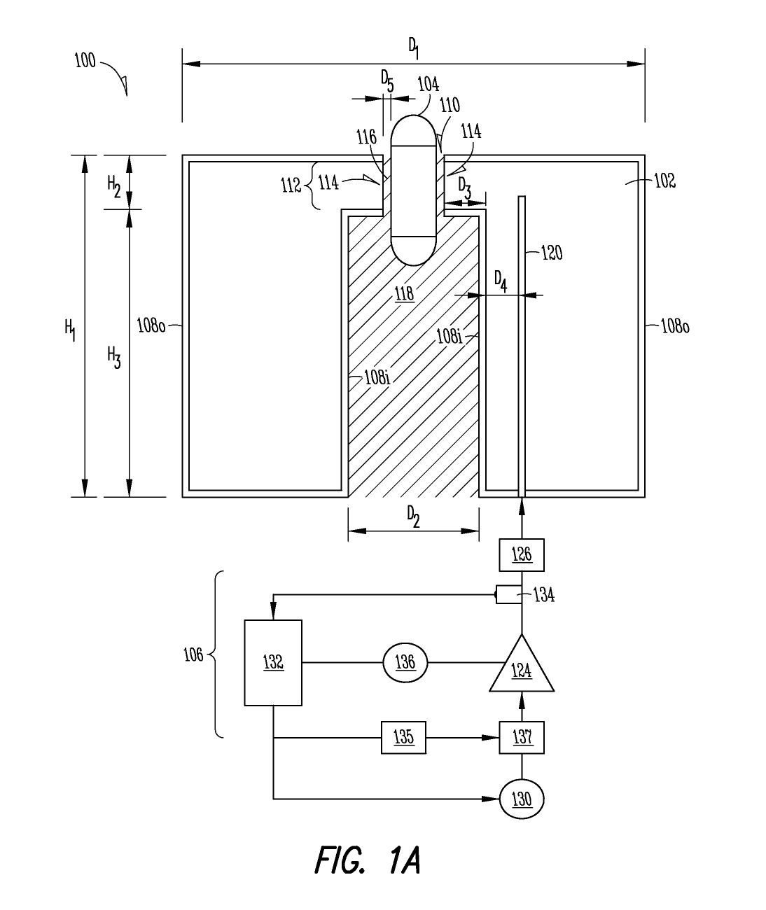

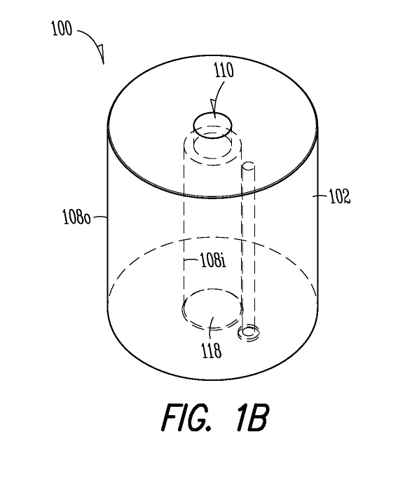

FIG. 1A is a cross-section and schematic view of a plasma lamp 100 according to an example embodiment. This is an example only and other plasma lamps may be used with other embodiments, including microwave or inductive plasma lamps. In the example of FIG. 1A, the plasma lamp 100 may have a lamp body 102 formed from one or more solid dielectric materials and a bulb 104 positioned adjacent to the lamp body 102. In one example embodiment, the lamp body 102 is formed from solid alumina having a relative permittivity of about 9.2. The bulb 104 contains a fill that is capable of forming a light emitting plasma. A lamp drive circuit 106 couples radio frequency power into the lamp body 102 which, in turn, is coupled into the fill in the bulb 104 to form the light emitting plasma. In example embodiments, the lamp body 102 forms a resonant structure that contains the radio frequency power and provides it to the fill in the bulb 104.

In example embodiments, the lamp body 102 is relatively tall and is coated with an electrically conductive material. A recess 118 is formed inside the lamp body 102. The coating 108o on the outside of the lamp body 102 forms an outer conductor. The coating 108i inside the recess 118 forms an inner conductor. The outer conductor and inner conductor are grounded together by the conductive coating across the bottom of the lamp body 102. The outer conductor continues on top of the lamp body 102 and surrounds the bulb 104 near the top of the bulb 104 (although a portion of the bulb 104 extends beyond the outer conductor). The inner conductor also extends toward the bulb 104 and surrounds the bulb 104 near the bottom (although a portion of the bulb 104 extends beyond the inner conductor into the recess 118. Surfaces 114 of the lamp body 102 are not coated with a conductive material (the outer conductor and inner conductor form an open circuit proximate the bulb 104). When the length of the inner conductor H3 is about one quarter of the wavelength of the radio frequency power in this waveguide structure (λ_{g}), this structure approximates a quarter wave coaxial resonator. The short circuit end of the quarter wave resonator is found along the bottom of the lamp body 102 where the 108o and 108i are grounded together by conductive coating. The open circuit end of the quarter wave resonator is at the uncoated surface 114. This is in contrast to a wider and shorter configuration, which approximates a half wavelength resonant cavity rather than a quarter wave coaxial resonator.

In the example embodiment of FIG. 1A, an opening 110 extends through a thin region 112 of the lamp body 102. The surfaces 114 of the lamp body 102 in the opening 110 are uncoated and at least a portion of the bulb 104 may be positioned in the opening 110 to receive power from the lamp body 102. In example embodiments, the thickness H2 of the thin region 112 may range from 1 mm to 15 mm or any range subsumed therein and may be less than the outside length and/or interior length of the bulb 104. One or both ends of the bulb 104 may protrude from the opening 110 and extend beyond the electrically conductive coating on the outer surface of the lamp body 102. This helps avoid damage to the ends of the bulb 104 from the high intensity plasma formed adjacent to the region where power is coupled from the lamp body 102.

The inner and outer conductor provide a capacitive region of high electric field intensity in thin region 112 of the solid dielectric lamp body 102 proximate the bulb 104. This creates an electric field in the bulb 104 that is substantially aligned along the central axis of the bulb 104, substantially parallel to the cylindrical walls of the bulb 104. However, since the ends of the bulb 104 extend beyond the inner and outer conductors, the electric field and plasma is confined primarily in the middle region of the bulb 104 rather than impacting the ends of the bulb 104 (which may potentially damage the bulb 104). This thin region 112 of dielectric material bounded by the inner and outer conductors shapes and controls the electric field applied to the bulb 104.

In some embodiments, the height H1 is less than λ_{g}/4 due to the capacitance provided by the thin region 112. The frequency required to excite a particular resonant mode in the lamp body 102 also generally scales inversely to the square root of the relative permittivity (also referred to as the dielectric constant) of the lamp body 102. As a result, a higher relative permittivity results in a smaller lamp body 102 required for a particular resonant mode at a given frequency of power (or a lower frequency for a lamp body of a given size). Also, the lamp body 102 can have dimensions less than one half the wavelength of the RF power in the waveguide (less than λ_{g}/2) in contrast to a resonant cavity lamp. In example embodiments, both the height and diameter (or width) of the lamp body 102 is less than λ_{g}/2 for the resonant structure. In example embodiments, both the height H1 and diameter D1 (or width for rectangular and other shapes) of the lamp body 102 may be less than λ/2 in free space for the relative permittivity of the dielectric material used for the lamp body 102. In some embodiments, the inner conductor and outer conductor may not be parallel and may slope relative to one another or have an irregular shape. In other embodiments, the outer conductor and/or inner conductor may be rectangular or other shape.

High frequency simulation software may be used to help select the materials and shape of the lamp body 102 and electrically conductive coating to achieve desired resonant frequencies and field intensity distribution in the lamp body 102. The desired properties may then be fine-tuned empirically.

The lamp 100 has a drive probe 120 inserted into the lamp body 102 to provide radio frequency power to the lamp body 102. A lamp drive circuit 106 including a power supply, such as amplifier 124, may be coupled to the drive probe 120 to provide the radio frequency power. The amplifier 124 may be coupled to the drive probe 120 through a matching network 126 to provide impedance matching. In an example embodiment, the lamp drive circuit 106 is matched to the load (formed by the lamp body 102, bulb 104 and plasma) for the steady state operating conditions of the lamp 100. The lamp drive circuit 106 is matched to the load at the drive probe 120 using a matching network (not shown).

In example embodiments, the radio frequency power may be provided at or near a frequency that resonates within the resonant structure formed by the lamp body 102 and inner and outer conductors. In example embodiments, radio frequency power may be provided at a frequency in the range of between about 50 MHz and about 10 GHz or any range subsumed therein. The radio frequency power may be provided to drive probe 120 at or near a resonant frequency for lamp body 102. The frequency may be selected based on the dimensions, shape and relative permittivity of the lamp body 102 and length of the inner and outer conductors to provide resonance. In example embodiments, the frequency is selected for a quarter wave resonant mode for the resonant structure. In example embodiments, the RF power may be applied at a resonant frequency or in a range of from 0% to 10% above or below the resonant frequency or any range subsumed therein. In some embodiments, RF power may be applied in a range of from 0% to 5% above or below the resonant frequency. In some embodiments, power may be provided at one or more frequencies within the range of about 0 to 50 MHz above or below the resonant frequency or any range subsumed therein. In another example, the power may be provided at one or more frequencies within the resonant bandwidth for at least one resonant mode. The resonant bandwidth is the full frequency width at half maximum of power on either side of the resonant frequency (on a plot of frequency versus power for the resonant cavity).

In example embodiments, the radio frequency power causes a light emitting plasma discharge in the bulb 104. In example embodiments, power is provided by RF wave coupling. In example embodiments, RF power is coupled at a frequency that forms approximately a standing quarter waveform in the lamp body 102 for the particular resonant structure.

In example embodiments, the electrodeless plasma lamp 100 according to example embodiments may be used in street and area lighting, entertainment lighting or architectural lighting or other lighting applications. In particular examples, the lamp 100 is used in overhead street lighting fixtures, moving head entertainment fixtures, fixed spot fixtures, architectural lighting fixtures or event lighting fixtures.

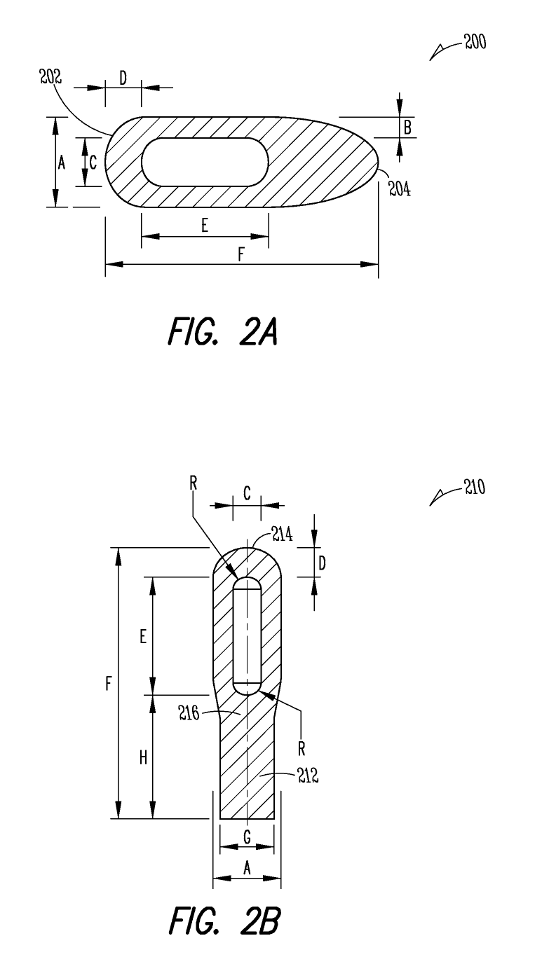

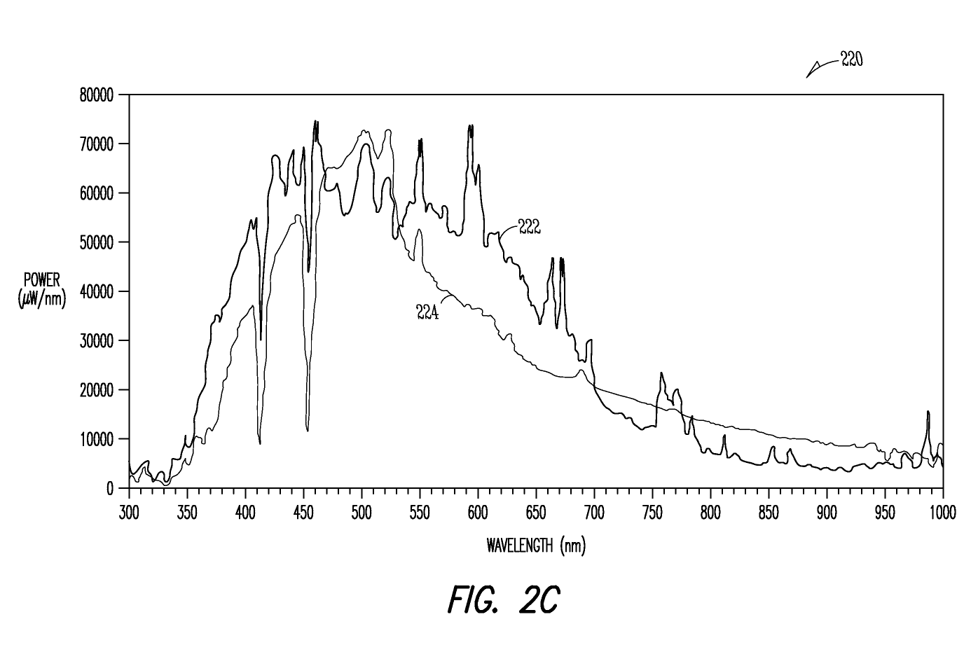

In some examples, the bulb 104 may be quartz, sapphire, ceramic or other desired bulb material and may be cylindrical, pill shaped, spherical or other desired shape. In an example embodiment shown in FIG. 2A, a bulb 200 is cylindrical in the center and forms a hemisphere at each end 202, 204. In one example embodiment, the outer length F (from tip to tip) is about 15 mm and the outer diameter A (at the center) is about 5 mm. In this example embodiment, the interior of the bulb 200 (which contains the fill) has an interior length E of about 9 mm and an interior diameter C at the center) of about 2.2 mm. The wall thickness B is about 1.4 mm along the sides of the cylindrical portion. The wall thickness D at the front end 202 is about 2.25 mm. The wall thickness at the other end 204 is about 3.75 mm. In this example, the interior bulb volume is about 31.42 mm³. In example embodiments where power is provided during steady state operation at between about 150-200 watts (or any range subsumed therein), this results in a power density in the range of about 4.77 watts per mm³ to 6.37 watts per mm³ (4770 to 6370 watts per cm³) or any range subsumed therein. In this example embodiment, the interior surface area of the bulb 200 is about 62.2 mm² (0.622 cm²) and the wall loading (power over interior surface area) is in the range of about 2.41 watts per mm² to 3.22 watts per mm² (241 to 322 watts per cm²) or any range subsumed therein.

In another example embodiment, the interior of the bulb 200 (which contains the fill) has an interior length E of about 9 mm and an interior diameter C at the center) of about 2 mm. The wall thickness B is about 1.5 mm along the sides of the cylindrical portion. The wall thickness D at the front end 202 (through which light is transmitted out of the lamp 100) is about 2.25 mm. In this example embodiment, the interior bulb volume is about 26.18 mm³. The wall thickness at the other end 204 is about 3.75 mm. In example embodiments where power is provided during steady state operation at between about 150-200 watts (or any range subsumed therein), this results in a power density in the range of about 5.73 watts per mm³ to 7.64 watts per mm³ (5730 to 7640 watts per cm³) or any range subsumed therein. In this example embodiment, the interior surface area of the bulb 200 is about 56.5 mm² (0.565 cm²) and the wall loading (power over interior surface area) is in the range of about 2.65 watts per mm² to 3.54 watts per mm² (265 to 354 watts per cm²) or any range subsumed therein.

In another example embodiment shown in FIG. 2B, a bulb 210 may have a tail 212 extending from one end of the bulb 210. In some embodiments, the length of the tail 212 (indicated at H in FIG. 2G) may be between about 2 mm and 25 mm or any range subsumed therein. In some example embodiments, a longer or shorter tail may be used. In one example embodiment, the length of the tail 212, H, is about 9.5 mm. In this example embodiment, the outer length of the bulb 210 (excluding the tail) is about 15 mm and the outer diameter A (at the center) is about 5 mm. In this example embodiment, the interior of the bulb 210 (which contains the fill) has an interior length E of about 9 mm and an interior diameter C at the center) of about 2.2 mm. The wall thickness B is about 1.4 mm along the sides of the cylindrical portion. The wall thickness D at a front end 214 is about 2.25 mm. The radius R is about 1.1 mm. In this example embodiment, the interior bulb volume is about 31.42 mm³. The tail 212 may be formed by using a quartz tube to form the bulb 210. The tube is sealed at one end which forms the front end 214 of the bulb 210. The bulb 210 is filled through the open end of the tube and sealed. The sealed tube is then placed in a liquid nitrogen bath and a torch is used to collapse the tube at the other end of the lamp 100, which seals the bulb 210 and forms the tail 212. The collapsed tube is then cut for the desired tail length.

In another example embodiment as shown in FIG. 2B, the bulb inner shape may be a nominal cylinder with two hemispheres at the ends 214, 216 having about the same radius as the cylindrical part. In this example, the inner length E is about 14 mm, the inner diameter C is about 4 mm (with an inner radius of about 2 mm), the outer diameter A is about 8 mm (with an outer radius of about 4 mm), and the length of the bulb 210 (excluding the tail 212) is about 20 mm. In this example, the length H of the tail 212 is about 10 mm.

In some example embodiments, the tail 212 may be used as a light pipe to sense the level of light in the bulb 210. This may be used to determine ignition, peak brightness or other state information regarding the lamp 100. Light detected through the tail can also be used by the drive circuit 106 for dimming and other control functions. A photodiode can sense light from the bulb 210 through the tail 212. The level of light can then be used by the drive circuit 106 to control the lamp 100. The back of the lamp 100 can be enclosed by a cover to avoid interference from external light from the surrounding environment. This isolates the region where light is detected by the photodiode and helps avoid interference that might be present if light is detected from the front of the lamp 100.

In some example embodiments, the tail may be used to align the bulb 210 and mount it in position. For example, the recess 118 may be packed with alumina powder. A plate or cement or other material may be used to cover the back of the recess 118 and hold the powder in place. This layer may form a rigid structure to which the bulb tail 212 may be mounted and fixed in position relative to the lamp body 102. For example, a layer of cement may be placed across the back surface of the powder and the tail 212 of the bulb 210 may be placed in the cement before it is cured. The cured cement holds the bulb 210 in place and forms a rigid layer that is fixed in position relative to the lamp body 102. In some example embodiments, the tail 212 may also provide additional heat sinking to the back end of the bulb 210. To the extent that the dose amounts result in a condensed pool of metal halide during operation of the lamp 100, the tail 212 helps form the pool at the cooler region at the back of the bulb 210, rather than at the front of the bulb 210 through which light is transmitted out of the lamp 100.

In other example embodiments, the bulb 210 may have an interior width or diameter in a range between about 2 and 30 mm or any range subsumed therein, a wall thickness in a range between about 0.5 and 4 mm or any range subsumed therein, and an interior length between about 2 and 30 mm or any range subsumed therein. In example embodiments, the interior bulb volume may range from 10 mm³ and 750 mm³ or any range subsumed therein. In some embodiments, the bulb volume is less than about 100 mm³. In example embodiments where power is provided during steady state operation at between about 150-200 watts, this results in a power density in the range of about 1.5 watts per mm³ to 2 watts per mm³ (1500 to 2000 watts per cm³) or any range subsumed therein. In this example embodiment, the interior surface area of the bulb is about 55.3 mm² (0.553 cm²) and the wall loading (power over interior surface area) is in the range of about 2.71 watts per mm² to 3.62 watts per mm² (271 to 362 watts per cm²) or any range subsumed therein. In some embodiments, the wall loading (power over interior surface area) may be 1 watts per mm² (100 watts per cm²) or more. These dimensions are examples only and other embodiments may use bulbs having different dimensions. For example, some embodiments may use power levels during steady state operation of 400-500 watts or more, depending upon the target application.

In example embodiments, the bulb 104 contains a fill that forms a light emitting plasma when radio frequency power is received from the lamp body 102. The fill may include a noble gas and a metal halide. Additives such as Mercury may also be used. An ignition enhancer may also be used. A small amount of an inert radioactive emitter such as Kr₈₅ may be used for this purpose. Some example embodiments may use a combination of metal halides to produce a desired spectrum and lifetime characteristics. In some example embodiments, a first metal halide is used in combination with a second metal halide. In some example embodiments, the first metal halide is Aluminum Halide, Gallium Halide, Indium Halide, Thallium Halide and Cesium Halide and the second metal halide is a halide of a metal from the Lanthanide series. In example embodiments, the does amount of the first metal halide is in the range of from about from 1 to 50 micrograms per cubic millimeter of bulb volume, or any range subsumed therein and the dose amount of the second metal halide is in the range of from about from 1 to 50 micrograms per cubic millimeter of bulb volume, or any range subsumed therein. In some embodiments, the dose of the first metal halide and the dose of the second metal halide are each in the range of from about 10 to 10,000 micrograms or any range subsumed therein. In example embodiments, these dose amount result in a condensed pool of metal halide during operation of the lamp 100. A noble gas and additives such as Mercury may also be used. In example embodiments, the dose amount of Mercury is in the range of 10 to 100 micrograms of Mercury per mm³ of bulb volume, or any range subsumed therein. In some embodiments, the dose of Mercury may be in the range of from about 0.5 to 5 milligrams or any range subsumed therein. An ignition enhancer may also be used. A small amount of an inert radioactive emitter such as Kr₈₅ may be used for this purpose. In some example embodiments, Kr₈₅ may be provided in the range of about 5 nanoCurie to 1 microCurie or any range subsumed therein.

In a particular example embodiment, the fill includes the first metal halide as an Iodide or Bromide in the range from about 0.05 mg to 0.3 mg or any range subsumed therein, and the second metal halide as an Iodide or Bromide in the range from about 0.05 mg to 0.3 mg or any range subsumed therein. Chlorides may also be used in some embodiments. In some example embodiments, the first metal halide and the second metal halide are provided in equal amounts. In other embodiments, the ratio of the first metal halide to the second metal halide may be 10:90, 20:80, 30:70, 40:60, 60:40, 70:30, 80:20 or 90:10.

In some example embodiments, the first metal halide is Aluminum Halide, Gallium Halide, Indium Halide or Thallium Halide (or a combination of Aluminum Halide, Gallium Halide, Indium Halide and/or Thallium Halide). In some example embodiments, the first metal halide may be Cesium Halide (or Cesium Halide in combination with Aluminum Halide, Gallium Halide, Indium Halide and/or Thallium Halide). In other example embodiments, the dose does not include any Alkalai metals. In some example embodiments, the second metal halide is Holmium Halide, Erbium Halide or Thulium Halide (or a combination of one or more of these metal halides). In these example embodiments, the first metal halide may be provided in a dose amount in the range of about 0.3 mg/cc to 3 mg/cc or any range subsumed therein and the second metal halide may be provided in a dose amount in the range of about 0.15 mg/cc to 1.5 mg/cc or any range subsumed therein. In some example embodiments, the first metal halide may be provided in a dose amount in the range of about 0.9 mg/cc to 1.5 mg/cc or any range subsumed therein and the second metal halide may be provided in a dose amount in the range of about 0.3 mg/cc to 1 mg/cc or any range subsumed therein. In some example embodiments, the first metal halide is provided in a larger dose amount than the second metal halide. In some examples, the first metal halide is Aluminum Bromide or Indium Bromide and the second metal halide is Holmium Bromide. In some example embodiments, the fill also includes Argon or another noble gas at a pressure in the range of about 50 to 760 Ton or any range subsumed therein. In some example embodiments, the pressure is 100 Ton or more or 150 Ton or more or may be at higher pressures as described below. In one example, Argon at 150 Ton may be used. Mercury and an inert radioactive emitter such as Kr₈₅ may also be included in the fill. In some example embodiments, a power of 100 watts or more may be provided to bulb 104 of the lamp 100. In some example embodiments, the power is in the range of about 150 to 200 watts, with 170 watts being used in a particular example. The wall loading may be 1 watts per mm² (100 watts per cm²) or more. A thermally conductive material, such as alumina powder, may be in contact with the bulb to allow high wall loading to be used as described below. In some example embodiments, as described further below, these fills may be used to provide 15,000 to 20,000 lumens (or any range subsumed therein) when operated at 150 to 200 watts (or any range subsumed therein). This can provide a luminous efficiency of 100 lumens per watt or more in some embodiments. Example embodiments may also provide at a correlated color temperature of 4000 to 10000 K (or any range subsumed therein) with a bulb geometry enabling the collection of 4500 to 5500 lumens (or any range subsumed therein) in 27 mm2 steradian when operated at 150 to 200 watts (or any range subsumed therein). In some example embodiments, the fill may be selected to provide a correlated color temperature in the range of 6000 to 9000 K.

Other metal halides may also be used in other example embodiments, including Bromides, Iodides and Chlorides of Indium, Aluminum, Gallium, Thallium, Holmium, Dysprosium, Cerium, Cesium, Erbium, Thulium, Lutetium and Gadolinium. Other metal halides may also be used in other embodiments, including Bromides, Iodides and Chlorides of Sodium, Calcium, Strontium, Yttrium, Tin, Antimony, Thorium and any of the elements in the Lanthanide series.

Some example embodiments may use a combination of metal halides to produce a desired spectrum. In some examples, one or more metal halides with strong emission in the blue color range (such as halides of Aluminum, Cesium, Gallium, Indium and/or Scandium) may be combined with one or more metal halides to enhance emission in the red color range (such as halides of Sodium, Calcium, Strontium, Gadolinium, Dysprosium, Holmium, Erbium and/or Thulium). In particular example embodiments, the fill may include (1) Aluminum Halide and Holmium Halide; (2) Aluminum Halide and Erbium Halide; (3) Gallium Halide and Holmium Halide; (4) Gallium Halide and Erbium Halide; (5) any of these fill further including Indium Halide; (6) any of these fills further including an alkali metal halide such as Sodium Halide or Cesium Halide (although other examples may specifically exclude all alkali metals); and (7) any of these fills further including Cerium Halide.

In an example embodiment, the metal halide(s) may be provided in the range from about 0.01 mg to 10 mg or any range subsumed therein and Mercury may be provided in the range of about 0.01 to 10 mg or any range subsumed therein. In example embodiments, the fill includes 1 to 100 micrograms of metal halide per mm³ of bulb volume, or any range subsumed therein, 1 to 100 micrograms of Mercury per mm³ of bulb volume, or any range subsumed therein, and 5 nanoCurie to 1 microCurie of a radioactive ignition enhancer, or any range subsumed therein. In other examples, the fill may include a dose of one or more metal halides in the range of about 1 to 100 micrograms of metal halide per mm³ of bulb volume without Mercury. In some embodiments using more than one metal halide, the total dose may be in any of the above ranges and the percentage of each metal halide may range from 5% to 95% of the total dose or any range subsumed therein.

These doses are examples only and other embodiments may use different doses and/or different fill materials. In other embodiments, different fills such as Sulfur, Selenium or Tellurium may also be used. In some examples, a metal halide such as Cesium Bromide may be added to stabilize a discharge of Sulfur, Selenium or Tellurium. Metal halide may also be added to a fill of Sulfur, Selenium or Tellurium to change the spectrum of the discharge.

In some example embodiments, a high pressure fill is used to increase the resistance of the gas. This can be used to decrease the overall startup time required to reach full brightness for steady state operation. In one example, a noble gas such as Helium, Neon, Argon, Krypton or Xenon, or another substantially non-reactive gas such as Nitrogen, or a combination of these gases is provided at high pressures between 200 Ton to 3000 Ton or any range subsumed therein. Pressures less than or equal to 760 Ton may be desired in some embodiments to facilitate filling the bulb at or below atmospheric pressure. In particular embodiments, pressures between 400 Ton and 600 Ton are used to enhance starting. Example high pressure fills may also include metal halide (or a combination of metal halides as described above) and Mercury which have a relatively low vapor pressure at room temperature. Example metal halide and Mercury fills include, but are not limited to, the fills described in Table 1 below. A bulb 200, 210 as described in connection with FIG. 2A or FIG. 2B may be used with these fills in example embodiments. In one example, the bulb 200, 210 has a volume of about 31.42 mm³ as described above.

TABLE 1

| Fill | InBr | | DyI₃ | | CeI₃ | | HoBr₃ | | AlBr₃ | | ErBr₃ | | GdI₃ | | HoI₃ | | Hg |
|---|---|---|---|---|---|---|---|---|---|---|---|---|---|---|---|---|---|
| #1 | 0.1 | mg | 0.1 | mg | 0 | | 0 | | 0 | | 0 | | 0 | | 0 | | 2.7 mg |
| #2 | 0.1 | mg | 0 | | 0.1 | mg | 0 | | 0 | | 0 | | 0 | | 0 | | 2.7 mg |
| #3 | 0 | | 0 | | 0 | | 0.05 | mg | 0.05 | mg | 0 | | 0 | | 0 | | 1.35 mg |
| #4 | 0.1 | mg | 0 | | 0 | | 0 | | 0.1 | mg | 0 | | 0 | | 0 | | 2.7 mg |
| #5 | 0.1 | mg | 0 | | 0 | | 0 | | 0 | | 0 | | 0.1 | mg | 0 | | 2.7 mg |
| #6 | 0.1 | mg | 0 | | 0 | | 0 | | 0 | | 0 | | 0 | | 0.1 | mg | 2.7 mg |
| #7 | 0.1 | mg | 0 | | 0 | | 0 | | 0 | | 0 | | 0 | | 0 | | 1.6 mg |
| #8 | 0 | | 0 | | 0 | | 0 | | 0.05 | mg | 0.05 | mg | 0 | | 0 | | 1.35 mg |
| #10 | 0.03 | mg | 0 | | 0 | | 0.01 | mg | 0 | | 0 | | 0 | | 0 | | 1.4 mg |
| #11 | 0.03 | mg | 0 | | 0 | | 0.03 | mg | 0 | | 0 | | 0 | | 0 | | 1.4 mg |
| #12 | 0.05 | mg | 0 | | 0 | | 0.01 | mg | 0 | | 0 | | 0 | | 0 | | 1.4 mg |
| #13 | 0.05 | mg | 0 | | 0 | | 0.03 | mg | 0 | | 0 | | 0 | | 0 | | 1.4 mg |

In example embodiments, these dose amount result in a condensed pool of metal halide during operation of the lamp 100. These fills can also be used without Mercury in some embodiments. In these examples, Argon or Krypton is provided at a pressure in the range of about 50 Ton to 760 Ton, depending upon desired startup characteristics. Some embodiments may use higher pressures. Initial breakdown of the noble gas is more difficult at higher pressure, but the overall warm up time required for the fill to substantially vaporize and reach peak brightness is reduced. The above fills may be used with or without an ignition enhancer. In some embodiments, these fills include Kr₈₅ in the range of about 5 nanoCurie to 1 microCurie or any range subsumed therein. Higher levels of ignition enhancer can be used to provide almost instantaneous ignition. The above pressures are measured at 22° C. (room temperature). It is understood that much higher pressures are achieved at operating temperatures after the plasma is formed. For example, the lamp 100 may provide a high intensity discharge at high pressure during operation (e.g., greater than 2 atmospheres and 10-100 atmospheres or more in example embodiments or any range subsumed therein). These pressures and fills are examples only and other pressures and fills may be used in other embodiments.

In a particular example embodiment, the fill includes about 0.5 μliter of Hg, about 0.1 mg of InBr, and about 0.01 mg of HoBr3. In this example, with reference to FIG. 2B, the bulb inner shape may be a nominal cylinder with two hemispheres at the ends 214, 216 having about the same radius as the cylindrical part, the inner length E is about 14 mm, the inner diameter C is about 4 mm (with an inner radius of about 2 mm), the outer diameter A is about 8 mm (with an outer radius of about 4 mm), and the length of the bulb 210 (excluding the tail 212) is about 20 mm. In this example, the length of the tail H is about 10 mm.

In another example, the bulb has a volume of about 31.42 mm cubed and the fill includes 0.01 milligram of InBr and 0.005 mg of HoBr3. In another example embodiment, the bulb has a volume of about 31.42 mm cubed and the fill includes 0.01 milligram of InBr and 0.005 mg of ErBr3. These fills may also include 1.4 mg of Mercury or may be Mercury free in some example embodiments. The fill may also include Kr₈₅ as an ignition enhancer in the does ranges described above. In this example embodiment, Argon or Krypton is provided at a pressure in the range of about 100 Ton to 200 Ton, depending upon desired startup characteristics. Some embodiments may use higher or lower pressures. Initial breakdown of the noble gas is more difficult at higher pressure, but the overall warm up time required for the fill to substantially vaporize and reach peak brightness is reduced.

FIG. 2H shows a graph of an example spectral power distribution 222 for the lamp 100 shown in FIG. 1A containing the example InBr/HoBr3 fill in microwatts per nanometer as collected in 27 mm² steradian at about 140 W operating power provided to the lamp 100. The graph 220 also shows an example spectral power distribution 224 for an Indium Bromide fill for comparison. As shown in FIG. 2H, the Indium/Holmium fill provides a brighter and more balanced spectrum. For example, the total radiated power between about 300-1000 nm collected in 27 mm² steradian at about 140 W operating power provided to the lamp body 102 is about 20.2 watts compared to 17.2 watts for Indium Bromide alone. In the range of 320 nm to 400 nm (part of the near UV spectrum, which may be useful for fluorescence excitation) the collected radiated power is about 1.8 watts for the In/Ho fill and 1.02 watts for In only. In the range of 400 nm to 700 nm (for visible illumination) the collected radiated power is about 15.9 watts for the In/Ho fill and 12.7 watts for In only. Each of the above can be expressed as a percentage of the total collected radiated power from 300 to 1000 nm in 27 mm² steradian and also as a percentage of input power to the lamp body 102 (in this case about 140 watts). Also, the color rendering for the Indium/Holmium fill is greater than 95% (about 97% in some embodiments) compared to 85% to 89% for Indium only fills. In example embodiments, the above characteristics are obtained for collected light in 30 mm² steradian or less.

The plasma arc produced in example embodiments is stable with low noise. Power is coupled symmetrically into the center region of the bulb from the lamp body 102 and is not disturbed by electrodes in the bulb (or degradation of those electrodes).

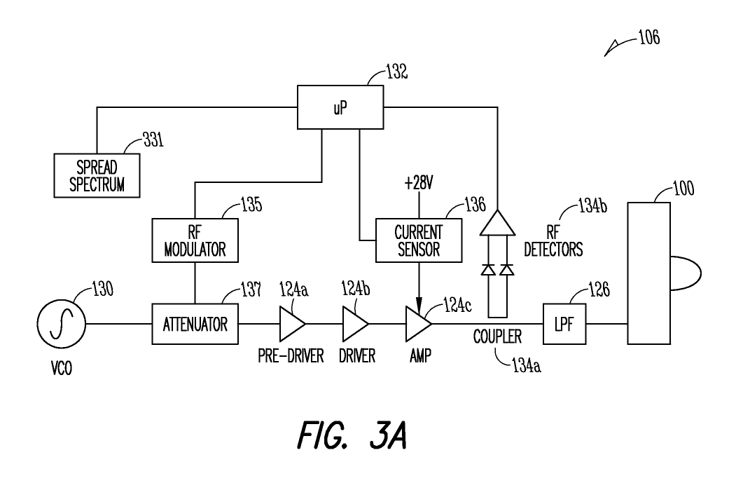

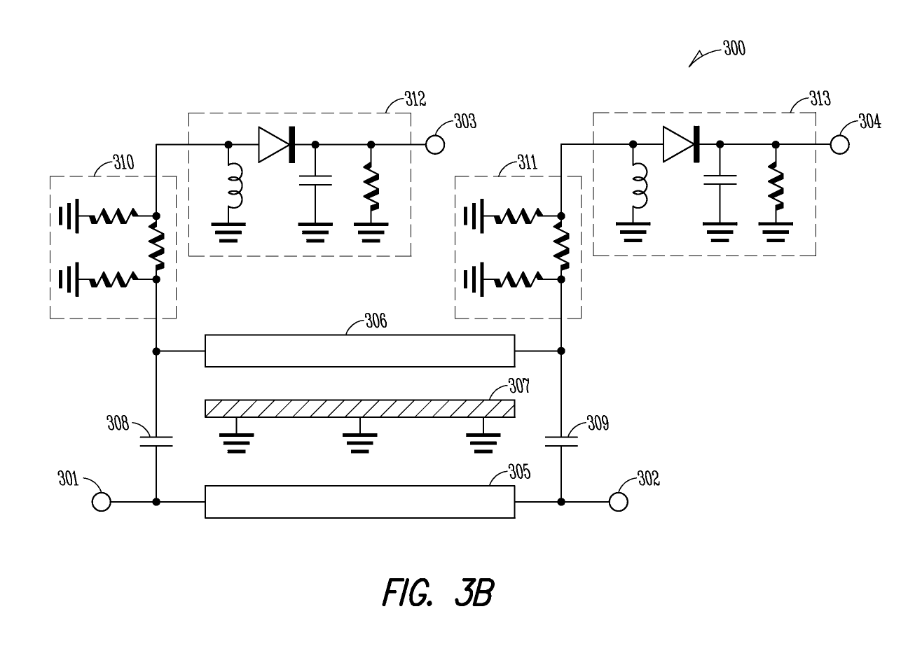

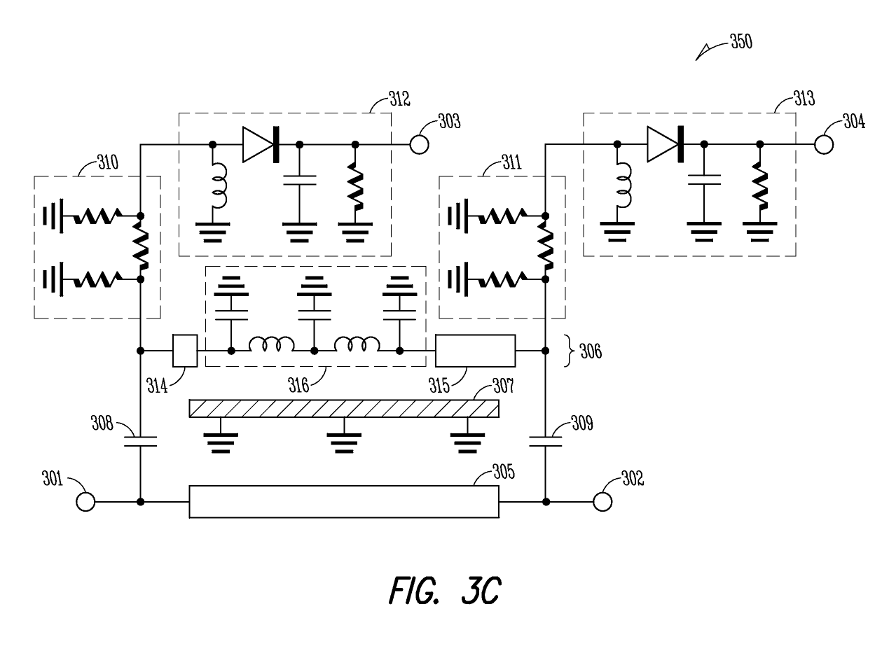

The drive circuit 106 and operation of the example lamp 100 will now be described with reference to FIG. 1A and FIG. 3. The drive circuit 106 includes a voltage controlled oscillator (VCO) 130, an RF modulator 135, an attenuator 137, a multi-stage amplifier 124, a low pass filter 126, a current sense circuit 136, microprocessor 132 or other controller, and radio frequency power detector 134. The VCO 130 is used to provide radio frequency power to the lamp body 102 at a desired frequency under control of microprocessor 132. The radio frequency power is amplified by amplifier 124 and provided to the lamp body 102 through low pass filter 126. The current sense circuit 136 and radio frequency power detector 134 may be used to detect the level of current and reflected power to determine the state of operation of the lamp 100. The microprocessor 132 uses the information from the current sense circuit 136 and the detector 134 to control the VCO 130, the RF modulator 135 and the attenuator 137 during startup and operation of the lamp 100, including startup, steady state operation and dimming and other control functions. In some embodiments, the microprocessor 132 may also control the gain of the amplifier 124.

The power to the lamp body 102 may be controlled by the drive circuit 106 to provide a desired startup sequence for igniting the plasma. As the plasma ignites and heats up during the startup process, the impedance and operating conditions of the lamp change. In order to provide for efficient power coupling during steady state operation of the lamp 100, the lamp drive circuit 106 is impedance matched to the steady state load of the lamp body 102, bulb 104 and plasma after the plasma is ignited and reaches steady state operating conditions. This allows power to be critically coupled from the drive circuit 106 to the lamp body 102 and plasma during steady state operation. However, the power from the drive circuit 106 is overcoupled to the lamp body 102 at ignition and during warm up of the plasma.

As shown in FIG. 3A, the VCO 130 provides RF power at a desired frequency to the multi-stage amplifier 124. In this example, the amplifier 124 has a pre-driver 124a, a driver 124b and a gain stage 124c controlled by the microprocessor 132. In some embodiments, the gain stage 124c may include two parallel gain stages (e.g., the circuit trace may split into parallel lines feeding power into both amplifier gain stages in parallel and the output from both amplifier stages may be recombined on the output side of the amplifier). The amplified RF power is provided to the probe 120 inserted into the lamp body 102 through the low pass filter 126. The current sense circuit 136 samples current in the drive circuit 106 and provides information regarding the current to the microprocessor 132. The RF power detector 134 (which includes a coupler 134a and RF detectors 134b) senses reflected or reverse power from the lamp body 102 and provides this information to the microprocessor 132. The microprocessor 132 uses these inputs to control the RF modulator 135 and the attenuator 137. The microprocessor 132 also uses this information to control the frequency of the VCO 130. A spread spectrum circuit 331 between the microprocessor 132 and VCO 130 can be used to adjust the signal to the VCO 130 to spread the frequencies over a range to reduce EMI as described below.

FIG. 3B shows an example circuit 300 that can be used for the RF power detector 134 in some embodiments. The circuit 300 includes an RF input port 301 connected to an output of the amplifier 124, an RF output port 302 that goes to the lamp body 102, a DC output port 303 for detection of forward power and a DC output port 304 for detection of reflected power. The circuit 300 also includes a length of 50 ohm microstrip 305 carrying both forward and reflected power. As used below, λₘ refers to the signal wavelength in the microstrip 305. In example embodiments, this length should not be within about λₘ/20 of any multiple of λₘ/2 for proper operation of the circuit 300. In example embodiments, the length is an odd multiple of λₘ/4, although intermediate lengths are possible and may be desirable for minimizing the size of the circuit 300. The circuit 300 also has a corresponding length of 50 ohm microstrip 306 carrying a small sample of both forward and reflected power. In example embodiments, the total electrical length of the microstrip 306 should be about ∠306=∠305+λₘ/2 of the microstrip. The microstrips 305 and 306 are isolated from each other, typically by better than 40 dB at the RF frequency.

The circuit 300 also includes a grounded copper trace 307 between the microstrip 305 and the microstrip 306 to provide the required isolation, yet still allow a compact layout. An alternative is to space the microstrips 305 and 306 far apart, typically at least 5× the width of a 50 ohm line, measured from the edge of the microstrip 305 to the nearest edge of the microstrip 306. The circuit 300 also includes sampling capacitors 308 and 309 that pick up RF power from the microstrip 305 and transfer a small quantity of that power to the microstrip 306. Typical values range from 0.1 pF-1.0 pF. In some embodiments, each of capacitors 308 and 309 may be split into 2 or more capacitors arranged in series so as to not exceed the component's breakdown voltage rating. The circuit 300 also includes attenuators 310 and 311 with 50 ohm input and output impedance, and typical attenuation of 10 dB. These may be standard “pi” or “tee” resistor attenuators. The “pi” configuration is shown. Detector circuits 312 and 313 convert the sampled RF power into a DC voltage. These are typically standard single diode detectors, shown in FIG. 3B with an input inductor for video ground, a series diode, an output capacitor for RF ground, and an output load resistor.

FIG. 3C shows an alternative embodiment of the power detection circuit 350. In this embodiment, the components are the same as FIG. 3B, except that the microstrip 306 comprises a first microstrip trace 314, a second microstrip trace 315, and a low-pass LC network 316. The total electrical length of the microstrip 306 is still ∠306=∠305+λₘ/2. However, the low-pass LC network 316 has greatly enhanced phase length compared to a microstrip trace with the same physical length as low-pass LC network 316. This allows the microstrip 306 to be physically very short, while still satisfying the phase length condition. Typically, the microstrips 305 and 306 will be approximately the same physical length despite the extra λₘ/2 electrical length of the microstrip 306.

The low-pass LC network 316 uses the “slow-wave” effect of lumped low-pass networks to achieve a large phase shift in a small space. The L and C values should be chosen to satisfy the phase requirements of the microstrip 306, and also to give a 50 ohm input and output impedance at the frequency of operation.

The operation of the example power detector circuit 134 will now be described. The power detector circuit 134 works based on constructive and destructive interference of signals, depending on which path those signals take between the ports 301-304. For this example, ∠305=λₘ/4 is used, the optimal value. Consider the forward power coming from the amplifier entering the circuit at RF input port 301, and determine what happens at DC output port 303 due to that power. A first sample of the forward power arrives at the DC output port 303 through the capacitor 308 with phase shift ∠308. A second sample of the forward power arrives at the DC output port 303 through the path defined by the microstrip 305, the capacitor 309, the microstrip 306, with a phase shift ∠305+∠309+∠306. Since ∠308=∠309 (the capacitors are the same), the relative phase of the two samples at 303 is zero vs. ∠305+∠306. Due to the phase requirements of the circuit, that works out to ∠0 vs. 3λₘ/4. So there is some constructive interference at the DC output port 303 due to an input at RF input port 301.

Consider the forward power coming from the amplifier 124 entering the circuit at the RF input port 301, and determine what happens at DC output port 304 due to that power. A first sample of the forward power arrives at DC out put port 304 through the path defined by the capacitor 308, the microstrip 306 with phase shift ∠308+∠306. A second sample of the forward power arrives at DC output port 304 through the path defined by the microstrip 305, the capacitor 309 with a phase shift ∠305+∠309. Since ∠308=∠309 (the capacitors are the same), the relative phase of the two samples at the DC output port 304 is ∠305 vs. ∠306. Due to the phase requirements of the circuit, that works out to ∠0 vs. lambda_g/2. So there is total destructive interference at the DC output port 304 due to an input at RF input port 301.

Since the circuit is symmetrical, it can be shown the same way that the reflected power from the lamp body 102, which enters the circuit at RF output port 302, combines somewhat in-phase at DC output port 304, and totally out of phase at DC output port 303. Therefore, the DC output port 303 is the forward power output, and DC output port 304 is the reflected power output.

The optimal electrical length of the microstrip 305 as an odd multiple of lambda/4 makes the input impedance of the circuit at either RF input port 301 or DC output port 302 appear to be exactly 50 ohms at the operating frequency. Any other choice will make the input impedance be somewhat different from 50 ohms, but the difference is small as long as the capacitors 308 and 309 are small capacitors. Typical values at 450 MHz are 0.5 pF.

The coupler circuits 300, 350 in FIGS. 3A and 3B may provide advantages over certain other coupler circuits. In finding the frequency of a resonant load, the load impedance changes significantly across frequency, degrading coupler performance. Specifically, the coupler parameter commonly known as directivity suffers when trying to measure reflected power from a resonant load that is excited with an off-resonant frequency. Poor directivity means that the forward power “leaks” into the reflected power detector, corrupting the measurement. The coupler circuits in FIGS. 3B and 3C avoid this problem.

In addition, the coupler circuits 300, 350 of FIGS. 3B and 3C can be made very small, even at low frequencies (large lambda_g) due to the minimal constraints on phase lengths of the microstrips 305 and 306, and also because the microstrip 306 can be physically shortened by the use of the low-pass LC network 316 while maintaining the required electrical length. While example embodiments of this coupler may not offer the accuracy required for some coupler applications, they can be used to make determinations of whether the load is on or off resonance with sufficient accuracy for example embodiments of the lamp 100 and at low cost.

Example operation of the overall drive circuit for the lamp 100 during ignition, warm up and run modes will now be described. During ignition, the microprocessor 132 ramps the VCO 130 through a series of frequencies until ignition is detected by detecting a sudden drop in reflected power from the detector 134. The microprocessor 132 also adjusts the RF modulator 135 and the attenuator 137 based on the current sense circuit 136 to maintain the desired current level in the circuit. Once a predetermined drop in reflected power level is detected indicating ignition, the microprocessor 132 enters a warm up state. During warm up, the microprocessor 132 ramps the VCO frequency through a pre-defined range and keeps track of the reflected power from the detector at each frequency. It then adjusts the frequency to the level determined to have the lowest reflected power. Once the detector senses reflected power below a threshold level indicating completion of warm up, the microprocessor 132 enters run state. In run state, the microprocessor 132 adjusts the frequency up and down in small increments to determine whether the frequency should be adjusted to achieve a target reflected power level with the minimum current.

In some embodiments, ripple current can be detected in the drive circuit 106 instead of or in addition to reflected power. When the frequency of the VCO 130 is modulated (for example, when the spread spectrum circuit 331 is used) and the circuit is off of the resonance frequency, a ripple current will result in some example embodiments. Changes in current based on frequency increase as the frequency moves away from the resonant frequency. This causes a ripple when the frequency is spread by the spread spectrum circuit 331. As mentioned above, the frequency of the VCO 130 can be incremented through ranges to find the frequency resulting in the lowest ripple current and to compare the ripple current against threshold values indicating ignition, warm up and run state. In example embodiments, the ripple current may be used to determine and adjust the operating condition of the lamp 100 instead of (or in addition to) RF power levels and/or a photodetector. In some cases, the ripple current may have a better correlation to some lamp operating conditions to be detected by the drive circuit 106 and reverse power may have a better correlation to other lamp operating conditions to be detected by the drive circuit 106. In this case, ripple current and reflected power could each be detected and used when appropriate to determine lamp operating conditions to adjust the operation of the lamp 100. The lamp operating conditions to be detected by the drive circuit 106 (and which may result in the microprocessor 132 adjusting the operation of the drive circuit 106) may include, for example, ignition, warm up and run modes, failure modes (for example, where the lamp 100 extinguishes after ignition without the lamp 100 being turned off) and brightness adjustment.

In some embodiments, reverse power and/or ripple current may be used to control the drive circuit 106 without a photodetector that detects light output from the lamp 100. This approach may facilitate deployment of the lamp 100 in configurations where the lamp body 102 and drive circuit 106 are remote from one another. For example, a coaxial cable or other transmission line may be used to transmit power from the drive circuit 106 to the drive probe 120 and the lamp body 102. In some configurations such as street and area lighting, the drive circuit 106 and other electronics may be deployed in a housing spaced apart from the lamp body 102 and/or fixture holding the lamp body 102. A cable may then feed the RF power to the probe 120 and the lamp body 102. In some of these embodiments, it may be difficult to channel light detected from the output of the lamp 100 back to the drive electronics. The use of ripple current and/or reflected power to control the drive circuit 106 may avoid this issue.

In some embodiments, the lamp 100 can be dimmed to low light levels less than 10%, 5% or 1% of peak brightness or even less in some embodiments. In some embodiments, upon receiving the dimming command, the microprocessor 132 can adjust the attenuator 137 (and/or amplifier gain in some embodiments) to dim the lamp 100. The microprocessor 132 also continues to make small adjustments in frequency to optimize the frequency for the new target reflected power level for the desired operating conditions.

In an alternate embodiment, the lamp 100 can be dimmed using pulse width modulation. The power may be pulsed on and off at high frequency at different duty cycles to achieve dimming. For example, in some examples, pulse width modulation may occur at a frequency of 1 kHz to 1000 kHz or any range subsumed therein. In one example embodiment, a pulsing frequency of about 10 kHz is used. This provides a period of about 0.1 milliseconds (100 microseconds). In another example, a pulsing frequency of about 500 kHz is used. This provides a period of about 2 microseconds. In other examples, the period may range from about 1 millisecond (at 1 kHz) to 1 microsecond (at 1000 kHz) or any range subsumed therein. However, the plasma response time is slower, so the pulse width modulation does not turn the lamp 100 off. Rather, the average power to the lamp 100 can be reduced by turning the power off during a portion of the period according to a duty cycle. For example, microprocessor 132 may turn off the VCO 130 during a portion of the period to lower the average power provided to the lamp 100. Alternatively, an attenuator may be used between the VCO 130 and amplifier to turn off the power. In other embodiments, the microprocessor 132 may switch on and off one of the low-power gain stages of the multi-stage amplifier 124, such as the pre-driver 124a. For example, if the duty cycle is 50%, the power will be off half of the time and the average power to the lamp 100 will be cut in half (resulting in dimming of the lamp 100).

This may be advantageous over dimming by adjusting the gain of the amplifiers in some embodiments, because the amplifier 124 can be kept in a more efficient operating range when power is applied. For example, when the power is on during the duty cycle, the amplifier 124 remains closer to peak power and/or saturation rather than operating the amplifier at lower gain and efficiency for dimming. In example embodiments, the duty cycle may range from 1%-99% or any range subsumed therein. In some embodiments, when complete dimming is desired (no light output), the lamp 100 may be dimmed to a low level (for example 1-5% of full brightness or less in some embodiments) using pulsing and a mechanical shutter can be used to block the light. In this example, the lamp 100 remains ignited, so it can rapidly be brought back up to full brightness (which may be desirable in various applications such as entertainment lighting). In some embodiments, the steady state power (even when the lamp 100 is not dimmed) may also use pulsing according to a duty cycle. The peak power of the amplifier 124 can be higher than the desired steady state operating conditions and pulsing can be used to reduce the average power to the desired level while maintaining amplifier efficiency.

In some examples, a power level to the amplifier 124 may be used that causes the amplifier 124 to operate at 70% to 95% efficiency or any range subsumed therein. In particular, in example embodiments, the high gain stage(s) of the amplifier 124, such as output stage 124c, may operate at 70% to 95% efficiency or any range subsumed therein. In example embodiments, the efficiency of the amplifier 124 (or high gain stage(s)) may be in the range of from about 70% to 100% of its peak efficiency or any range subsumed therein. In some examples, the power level may cause the amplifier 124 (and/or one or more high gain stage(s)) to operate at or near saturation. In some embodiments, the power level may be in the range of from about 70% to 100% or more of the power level required for saturation or any range subsumed therein. By pulsing the power at these levels, desired efficiency and operating conditions of the amplifier 124 may be maintained during dimming (or steady state operation in some embodiments) even when the efficiency and operating conditions would not be obtained if the power level was dropped to the same average power without pulsing. By keeping the amplifier 124 (or high gain stage(s) of the amplifier 124) in an efficient range and pulsing the power, the overall efficiency of the lamp 100 can be improved in some embodiments.

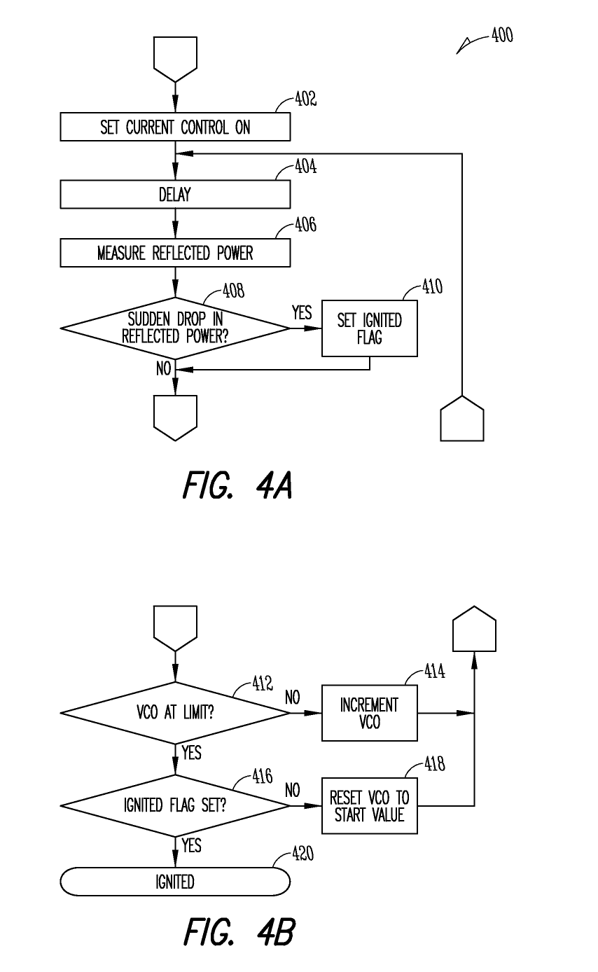

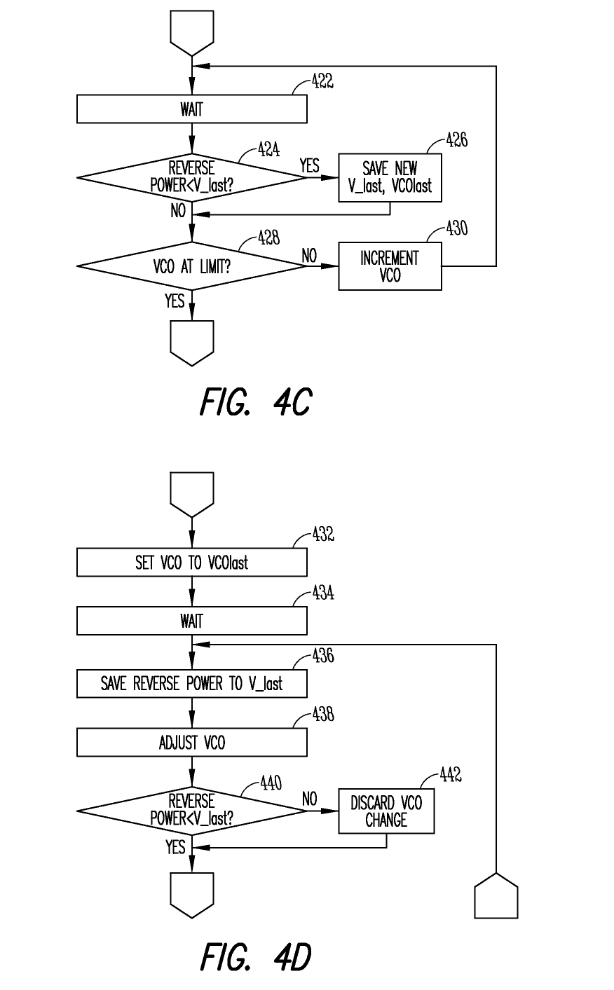

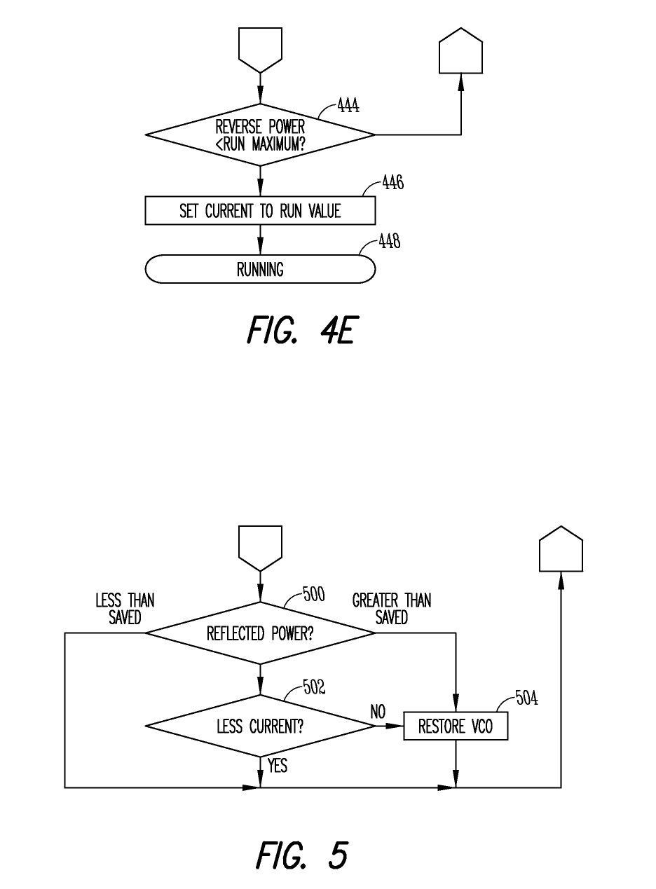

Example operation of the example lamp 100 and the drive circuit 106 during startup will now be described with reference to FIGS. 4A-E. Various start and threshold values used by the microprocessor 132 to control the lamp 100 may be determined empirically in advance when the lamp 100 is tested and configured. These values may be programmed into the microprocessor 132 and memory ahead of time and used as described below. The examples described below and in FIGS. 4 and 5 use reflected or reverse power to determine lamp operating conditions. In alternative embodiments, ripple current or light detected from a photodetector may be used or other detected conditions in the lamp 100 or drive circuit 106 may be used (for example, forward power or net power or other conditions). In some embodiments, a combination of detectors may be used (for example, different threshold values during startup or run mode may be determined using different techniques such as reflected power, ripple current or level of light detected).

In the example shown in FIG. 4, for ignition mode, the microprocessor 132 sets internal flags in memory (not shown) to indicate that the lamp 100 has not started. It then set the control voltage on the VCO 130 to the desired level for startup and turns the VCO 130 on. As shown in FIG. 4A, the microprocessor 132 then sets “current control” to on (see block 402), which prevents the drive circuit 106 from exceeding a maximum current (as determined by current sense circuit 136). After a delay 404, the microprocessor 132 then measures the reflected power (see block 406) and determines whether the value has dropped below a threshold which indicates ignition of the lamp 100 (see decision block 408). Upon ignition, as shown at block 410, the microprocessor 132 sets an ignited flag in memory to indicate that the fill in the bulb has ignited.

As shown at decision block 412 in FIG. 4B, the microprocessor 132 then increments the VCO 130 over a range of frequencies (see block 414). In one example embodiment, the VCO 130 is incremented over a range of about 50 MHz in steps of about 60 kHz (by adjusting the control voltage on the VCO 130 in steps of about 3 mV). In other embodiments, the frequency sweep may cover a range of about 10-100 MHz or any range subsumed therein in steps of 10 kHz-1 MHz or any range subsumed therein. These are examples only and other embodiments may use other ranges. As shown at blocks 416 and 418, this continues until the VCO 130 has stepped through the frequency range and the lamp 100 has ignited as shown a block 420 (as indicated by the ignited flag).

The lamp 100 then enters the warm up stage. The microprocessor 132 then sets adjusts the current in the circuit (as sensed by current sense circuit 136) to a predetermined level desired for warm up. The VCO 130 is set to its start value and stored by the microprocessor 132 in memory as VCOlast. The microprocessor 132 also reads the reverse power and saves the value as V_last.

As shown at FIG. 4C, the microprocessor 132 then increments the VCO 130 over a range of frequencies (in a similar manner to that described in connection with FIG. 4B). After a wait 422, the microprocessor 132 reads the reverse power after each increment (see block 424). If the reading is lower than the prior value (V_last), the microprocessor 132 saves the value read by the power detector as V_last and saves the VCO 130 level as VCOlast as shown in block 426. This continues until the VCO 130 has been incremented through the full range of warm up frequencies and reaches the upper limit of the range (see blocks 428 and 430).

As shown in FIG. 4D, the VCO 130 is then set to VCOlast (see block 432) and, after a wait 434, and the reverse power is read and saved as V_last (see block 436). As shown in block 438, the microprocessor 132 then adjusts the VCO 130 in small increments to see if it will decrease reflected power. This continues until the reverse power drops below the threshold required for run mode as show in FIG. 4E (see blocks 440 and 442). The microprocessor 132 then adjusts the current to the level desired for run mode as shown in FIG. 4E (see blocks 444, 446 and 448).

The operation of the lamp 100 in run mode will now be described with reference with FIG. 5. During run mode, the microprocessor 132 checks several conditions to see if there is a change in the mode of the lamp 100. For example, as shown at decision block 500, the microprocessor 132 may check that the level of reflected power is below the threshold level required for the run mode (which may indicate a failure condition). The microprocessor 132 may also checks for a stop command to shut off the lamp 100. The microprocessor 132 may also check for commands to change the brightness. The microprocessor 132 may also check if the lamp 100 is operating in a low brightness conditions (for example, less than 20% brightness) and, in some embodiments, may not further adjust the VCO 130 to optimize based on reverse power in low brightness modes.

After the preliminary status checks, the microprocessor 132 may change the frequency of the VCO 130 in small increments for optimization. As shown in FIG. 5, the level of reflected power is the primary measure used for optimization. If reflected power increases due to the VCO change, then the VCO change is discarded and the loop is repeated (preliminary status checks which may be followed by another change in VCO 130 to check for optimization), except that the VCO change will be made in the opposite direction the next time through the loop. If reflected power decreases due to the VCO change, then the VCO change is maintained and the loop is repeated (and the next VCO change will be made in the same direction since it reduced reflected power). If the reflected power is the same as the prior value in FIG. 5, then the current level is checked. If the current level is lower than the prior level, then the VCO change is maintained and the VCO 130 continues to be adjusted in the same direction. If the current level is not lower, then the VCO change is discarded and the VCO 130 will be adjusted in the opposite direction then next time through the loop (see blocks 502 and 504).

In some embodiments, the drive circuit 106 also includes a spread spectrum mode to reduce EMI. The spread spectrum mode is turned on by the spread spectrum controller or circuit 331. When spread spectrum is turned on, the signal to the VCO 130 is modulated to spread the power provided by the lamp circuit 106 over a larger bandwidth. This can reduce ElectroMagnetic Interference (EMI) at any one frequency and thereby help with compliance with FCC regulations regarding EMI. In example embodiments, the degree of spectral spreading may be from 5-30% or any range subsumed therein. In example embodiments, the modulation of the phase shifter 130 can be provided at a level that is effective in reducing EMI without any significant impact on the plasma in the bulb 104.

In some example embodiments, the amplifier 124 may also be operated at different bias conditions during different modes of operation for the lamp 100. The bias condition of the amplifier 124 may have a large impact on DC-RF efficiency. For example, an amplifier biased to operate in Class C mode is more efficient than an amplifier biased to operate in Class B mode, which in turn is more efficient than an amplifier biased to operate in Class A/B mode. However, an amplifier biased to operate in Class A/B mode has a better dynamic range than an amplifier biased to operate in Class B mode, which in turn has better dynamic range than an amplifier biased to operate in Class C mode.

In one example, when the lamp 100 is first turned on, the amplifier 124 is biased in a Class A/B mode. The Class A/B mode provides better dynamic range and more gain to allow amplifier 124 to ignite the plasma and to follow the resonant frequency of the lamp 100 as it adjusts during startup. Once the plasma reaches its steady state operating condition (run mode), the amplifier bias is removed which puts amplifier 124 into a Class C mode. This provides improved efficiency. However, the dynamic range in Class C mode may not be sufficient when the brightness of the lamp 100 is modulated below a certain level (e.g., less than 70% of full brightness). When the brightness is lowered below the threshold, the amplifier 124 may be changed back to Class A/B mode. Alternatively, Class B mode may be used in some embodiments.

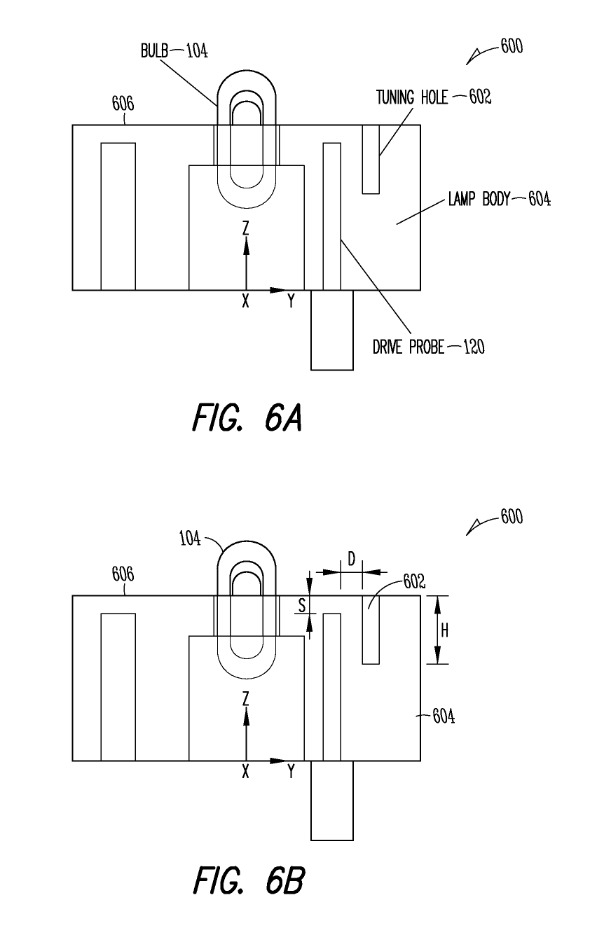

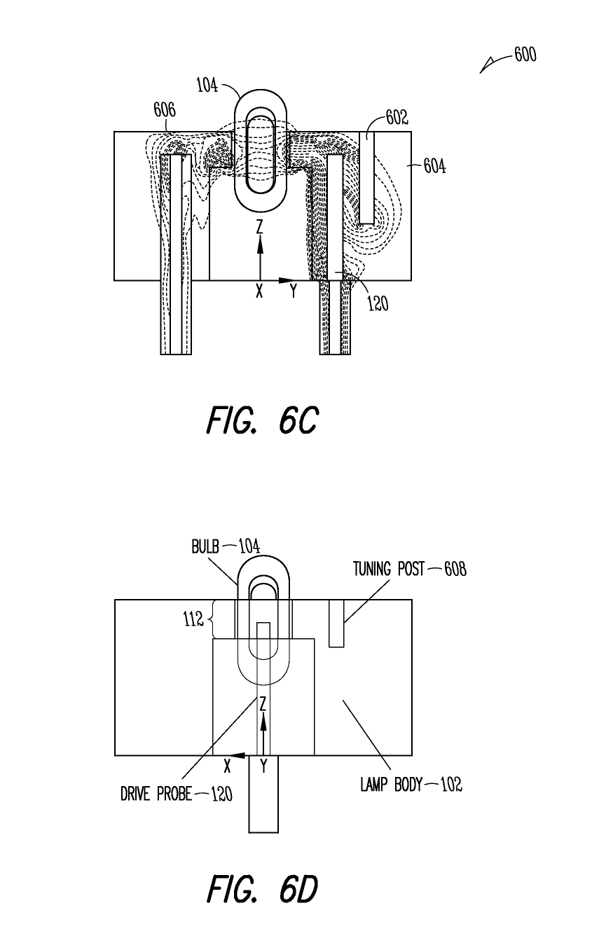

FIGS. 6A-D show example embodiments of a plasma lamp 600 using a tuning hole 602 in a lamp body 604 for impedance matching and/or frequency tuning. In the example embodiments shown in FIGS. 6A-D, one or more tuning holes 602 may be formed in the lamp body 604 to improve matching of the impedance of the probe 120 to the lamp body 604 and plasma during the run state and thereby reduce reflected power from the lamp body 604 and/or to adjust/tune the resonant frequency of the lamp body 604. In some examples, the tuning hole(s) 602 may be metallized or coated with a conductive material (or a conductive material may be inserted a desired length into the tuning hole 602). In other embodiments, the tuning hole 602 is not metallized and is uncoated. The examples shown in FIGS. 6A-D show tuning holes 602 in the lamp body 604 that is not as tall as the lamp body 102 shown in FIG. 1A. In example embodiments, the lamp 600 may operate in a resonant cavity mode rather than a quarter wave coaxial resonator mode. However, similar tuning holes 602 may be used in the embodiment shown in FIG. 1A or in other example embodiments that operate in a quarter wave coaxial resonator mode.

The following is an example description of how tuning holes 602 may be used for impedance matching with reference to FIGS. 6A-C. In some example embodiments, the depth of the drive probe 120 determines its capacitive coupling to the lamp body 604, which dictates the power transfer to the bulb 104 during the run state. There may be an optimum depth of the drive probe 120 that provides maximum power coupling to the bulb 104. In some embodiments, the depth of the drive probe 120 is constrained by failure modes like probe arcing to the top metallization of the lamp body 604. To achieve the required coupling without arcing in example embodiments, a tuning hole 600 may be used for matching the impedance of the probe 120 to the lamp body 604 and plasma during the run state. The dimensions S (distance from top metallized surface 606 of lamp body 604), D (distance between drive probe 120 and tuning hole 602) and H (height/depth of tuning hole 602) in the FIG. 6B can be chosen such that the reflected power from the lamp body 604 is reduced relative to the amount of reflected power without the tuning hole 602 and without arcing from the probe 120 to the top metallized surface 606. In this example, the tuning hole 602 may be metallized. The tuning hole 602 provides an additional path for capacitive coupling of the probe 120 to the top surface 606 of the lamp body 604. In some embodiment, this allows a wider range of probe depths to be evaluated for improving LPW (lumens per watt coupling efficiency) without affecting the impedance match. In example embodiments, the tuning hole 602 may also avoid probe arcing.

FIG. 6C is a simulation showing strong E-fields between the probe 120 and the tuning hole 602. In one example, the lamp 600 has a starting frequency of 937 MHz, net power of 180 W and a tuning hole 602 with dimensions S=3 mm, H=10 mm, and D=3 mm. In this example, reflected power is about 15 W. In another example, H is 13 mm and the reflected power drops to about 0.3 W (and the starting frequency is about 925 MHz).

The following is an example description of how tuning holes may be used for frequency tuning with reference to FIG. 6D. Since the thin region 112 of the lamp body 604 near the bulb 104 (shown at 112 in FIG. 1A) is a high field or equivalently a highly capacitive region, modifications or addition of metallic posts close to this region can alter the fields and hence the frequency of the lamp body 604 in example embodiments. In some embodiments, this may be used to tune the lamp body 604 into the frequency range of interest. In some example embodiments, metalizing a tuning post 608 reduces the frequency and leaving it unmetallized and moving it closer to or in the thin region 112 increases the frequency. In one example, a lamp without a tuning hole has a starting frequency of about 944 MHz. When a metallized tuning hole 602 with H of about 5 mm is included as shown in FIG. 6D, the starting frequency is about 924 MHz.

Additional aspects of electrodeless plasma lamps according to example embodiments will now be described with reference to FIGS. 1A and 1B. In example embodiments, the lamp body 102 has a relative permittivity greater than air. The frequency required for resonance generally scales inversely to the square root of the relative permittivity (also referred to as the dielectric constant) of the lamp body 102. The shape and dimensions of the lamp body 102 also affect the resonant frequency. In an example embodiment, the lamp body 102 is formed from solid alumina having a relative permittivity of about 9.2. In some embodiments, the dielectric material may have a relative permittivity in the range of from 2 to 100 or any range subsumed therein, or an even a higher relative permittivity. In some embodiments, the lamp body 102 may include more than one such dielectric material resulting in an effective relative permittivity for the lamp body 102 within any of the ranges described above. The lamp body 102 may be rectangular, cylindrical or other shape as described further below.

In example embodiments, the outer surfaces of the lamp body 102 may be coated with an electrically conductive coating, such as electroplating or a silver paint or other metallic paint which may be fired onto the outer surface of the lamp body 102. The electrically conductive material may be grounded and forms both the outer conductor and inner conductor for the coaxial resonant structure as described above. The electrically conductive coating also helps contain the radio frequency power in the lamp body 102. Regions of the lamp body 102 may remain uncoated to allow power to be transferred to or from the lamp body 102. For example, the bulb 104 may be positioned adjacent to an uncoated portion of the lamp body 102 to receive radio frequency power from the lamp body 102. Also, there may be a small gap in the coating where the probe is inserted into the lamp body 102. A high breakdown material, such as a layer of glass frit, may be coated on the outside of the electrically conductive coating to prevent arcing, including the edges of the conductive material that are spaced a few millimeters from one another by surfaces 114 of the lamp body 102.

In the example embodiment of FIG. 1A, an opening 110 extends through the thin region 112 of the lamp body 102. The surfaces 114 of the lamp body 102 in the opening 110 are uncoated and at least a portion of the bulb 104 may be positioned in the opening 110 to receive power from the lamp body 102. In example embodiments, the thickness H2 of the thin region 112 may range from 1 mm to 15 mm or any range subsumed therein and may be less than the outside length and/or interior length of the bulb 104. One or both ends of the bulb 104 may protrude from the opening 110 and extend beyond the electrically conductive coating on the outer surface of the lamp body 102. This may help avoid damage to the ends of the bulbs from the high intensity plasma formed adjacent to the region where power is coupled from the lamp body 102. In other embodiments, all or a portion of the bulb 104 may be positioned in a cavity extending from an opening on the outer surface of the lamp body 102 and terminating in the lamp body 102. In other embodiments, the bulb 104 may be positioned adjacent to an uncoated outer surface of the lamp body 102 or in a shallow recess formed on the outer surface of the lamp body 102.

A layer of material 116 may be placed between the bulb 104 and the dielectric material of lamp body 102. In example embodiments, the layer of material 116 may have a lower thermal conductivity than the lamp body 102 and may be used to optimize thermal conductivity between the bulb 104 and the lamp body 102. In an example embodiment, the layer 116 may have a thermal conductivity in the range of about 0.5 to 10 watts/meter-Kelvin (W/mK) or any range subsumed therein. For example, alumina powder with 55% packing density (45% fractional porosity) and thermal conductivity in a range of about 1 to 2 watts/meter-Kelvin (W/mK) may be used. In some embodiments, a centrifuge may be used to pack the alumina powder with high density. In an example embodiment, a layer of alumina powder is used with a thickness D5 within the range of about ⅛ mm to 1 mm or any range subsumed therein. Alternatively, a thin layer of a ceramic-based adhesive or an admixture of such adhesives may be used. Depending on the formulation, a wide range of thermal conductivities is available. In practice, once a layer composition is selected having a thermal conductivity close to the desired value, fine-tuning may be accomplished by altering the layer thickness. Some example embodiments may not include a separate layer of material around the bulb 104 and may provide a direct conductive path to the lamp body 102. Alternatively, the bulb 104 may be separated from the lamp body 102 by an air-gap (or other gas filled gap) or vacuum gap.

In some example embodiments, alumina powder or other material may also be packed into the recess 118 formed below the bulb 104. In the example shown in FIG. 1A, the alumina powder in the recess 118 is outside the boundaries of the waveguide formed by the electrically conductive material on the surfaces of the lamp body 102. The material in the recess 118 provides structural support, reflects light from the bulb and provides thermal conduction. One or more heat sinks may also be used around the sides and/or along the bottom surface of the lamp body 102 to manage temperature. Thermal modeling may be used to help select a lamp configuration providing a high peak plasma temperature resulting in high brightness, while remaining below the working temperature of the bulb material. Example thermal modeling software includes the TAS software package available commercially from Harvard Thermal, Inc. of Harvard, Mass.

In an example embodiment, the probe 120 may be a brass rod glued into the lamp body 102 using silver paint. In other embodiments, a sheath or jacket of ceramic or other material may be used around the probe, which may change the coupling to the lamp body 102. In an example embodiment, a printed circuit board (pcb) may be positioned transverse to the lamp body 102 for the drive electronics. The probe 120 may be soldered to the pcb and extend off the edge of the pcb into the lamp body 102 (parallel to the pcb and orthogonal to the lamp body 102). In other embodiments, the probe may be orthogonal to the pcb or may be connected to the lamp drive circuit 106 through SMA connectors or other connectors. In an alternative embodiment, the probe may be provided by a pcb trace and portions of the pcb board containing the trace may extend into the lamp body 102. Other radio frequency feeds may be used in other embodiments, such as microstrip lines or fin line antennas. In other embodiments, the probe 120 or probes may be connected to the drive circuit 106 by a coaxial cable or other transmission line.

In an example embodiment, the drive probe 120 is positioned closer to the bulb in the center of the lamp body 102 than the electrically conductive material 108o around the outer circumference of the lamp body 102. This positioning of the drive prove 120 can be used to improve coupling of power to the plasma in the bulb 104.

High frequency simulation software may be used to help select the materials and shape of the lamp body 102 and electrically conductive coating to achieve desired resonant frequencies and field intensity distribution in the lamp body 102. Simulations may be performed using software tools such as HFSS, available from Ansoft, Inc. of Pittsburgh, Pa., Multiphysics, available from COMSOL, Inc. of Burlington, Mass. or or Microwave Studio available from Computer Simulation Technology AG to determine the desired shape of the lamp body 102, resonant frequencies and field intensity distribution. The desired properties may then be fine-tuned empirically.

While a variety of materials, shapes and frequencies may be used, in some example embodiments, the aspect ratio of the lamp body 102 (length H1 divided by width or diameter D1) is about one. In some embodiments, the length H1 is more than the width D1 or more than 75%-100% of the width D1 or any range subsumed therein. In some examples, the lamp 100 is designed to resonate at a frequency of less than about 500 MHz or less than 200 MHz or lower in some examples. In some embodiments, the lamp 100 is configured to resonate in a fundamental mode at a frequency of between about 50 to 500 MHz or any range subsumed therein. In example embodiments operating at these frequencies, the length H1 is more than 40 mm. In some examples, the length H1 is more than three times the length of the bulb. In some examples, the length of the recess (and length of the inner conductor) is more than 30 mm or 35 mm or 40 mm or 45 mm (and in some of these example embodiments, the probe may have a length more than 30 mm or 35 mm or 40 mm or 45 mm and be substantially parallel to the length of the recess and the bulb 104). In some examples, the length of the inner conductor formed by the recess (H3) is more than three times the diameter of recess D2 and more than three times the length of the bulb 104. In some examples, the length H1 is greater than the diameter D1 (or width of the lamp body 102 for rectangular or other shapes). The outer conductive coating along length H1 and conductive coating along the recess form inner and outer coaxial conductive elements in some embodiments. This provides a coaxial capacitance substantially orthogonal to the length of the bulb 104. In contrast, the region 112 provides a shelf that provides a capacitance substantially parallel to the length of the bulb 104, which provides an electric field along the length of the bulb 104. The region 112 shapes the electric field and changes its orientation relative to the electric field formed between the inner and outer electrodes along the length of the lamp body 102. In some embodiments, the long coaxial capacitive region between the surface along H1 and the surface along the recess 118 is configured to provide approximately a quarter wave resonant structure. The additional capacitance provided in region 112 may also impact the resonant frequency relative to a coaxial structure without this region.

In one embodiment designed to operate at about 450 MHz, the length H1 (which is the length of outer conductor along the sides of the lamp 100) is about 45.5 mm and the diameter D1 is about 50 mm. The distance H1 (which is the length of the inner conductor in recess 118) is about 41 mm. In this example, the distance D2 is about 14 mm and D3 is about 2.5 mm (the diameter of the hole for the bulb is about 9 mm in diameter in this example). A narrow region 112 forms a shelf over the recess 118. The distance H2 is about 5 mm (more generally 2 to 10 mm or any range subsumed therein). This results in higher capacitance in this region of the lamp body 102 and higher electric field intensities. In this example, the probe has a length of about 41.5 mm. In this example, the lamp body 102 is alumina and has a relative permittivity of about 9.

In some embodiments, the relative permittivity is in the range of about 9-15 or any range subsumed therein, the frequency of the RF power is less than about 500 MHz and the volume of the lamp body 102 is in the range of about 10 cm³ to 75 cm³ or any range subsumed therein. In some of these examples, the RF power resonates in the resonant structure in a quarter wave mode and the outer dimensions of the lamp body 102 are all less than one half wavelength of the RF power in the resonant structure.

The above dimensions, shape, materials and operating parameters are examples only and other embodiments may use different dimensions, shape, materials and operating parameters.

What is claimed is:

1. An electrodeless plasma lamp comprising:
a power source to provide radio frequency (RF) power;
a bulb containing a fill that forms a plasma when the RF power is coupled to the fill; and
a resonant structure having a quarter wave resonant mode, the resonant structure including a lamp body comprising:
a dielectric material having a relative permittivity greater than 2;
an inner conductor; and
an outer conductor, the power source configured to provide the RF power to the lamp body at about a resonant frequency for the resonant structure.

2. The plasma lamp of claim 1, wherein the bulb is positioned proximate to a non-conductive surface of the lamp body.

3. The plasma lamp of claim 2, wherein at least a portion of the outer conductor is positioned proximate a first side of the non-conductive surface proximate the bulb and at least a portion of the inner conductor is positioned proximate a second side of the non-conductive surface proximate the bulb.

4. The plasma lamp of claim 3, wherein the non-conductive surface defines a cylindrical opening in which the bulb is at least partially received.

5. The plasma lamp of claim 4, wherein the lamp body is circular cylindrical in shape and includes a circular cylindrical recess, the outer conductor provided on an outer surface of the lamp body and the inner conductor being provided on an inner surface of the lamp body.

6. The plasma lamp of claim 5, further comprising the opening extends between the recess and an upper surface of the lamp body, surfaces of the lamp body defining the opening and the non-conductive surface.

7. The plasma lamp of claim 1, wherein the resonant structure forms an open circuit between the outer conductor and the inner conductor proximate the bulb.

8. The plasma lamp of claim 1, wherein the inner conductor and outer conductor form a short circuit in a region of the resonant structure opposite from the end of the structure that is proximate the bulb.

9. The plasma lamp of claim 1, wherein the bulb is elongate and a portion of the outer conductor is proximate a first end of bulb and a portion of the inner conductor is proximate a second end of the bulb and the resonant structure is configured to form an electric field in the bulb substantially parallel to a central axis of the bulb between the first end and the second end.

10. The plasma lamp of claim 9, wherein light formed by the plasma exits the lamp body at least from the first end of the bulb.

11. The plasma lamp of claim 1, wherein at least one end of the bulb protrudes outside of the resonant structure.

12. The plasma lamp of claim 1, wherein the bulb is elongate and both ends of the bulb protrude outside of the resonant structure, extending beyond the boundary formed by the outer conductor at a first end of the bulb and extending beyond a boundary formed by the inner conductor at a second end of the bulb.

13. The plasma lamp of claim 1, wherein the volume of the dielectric material is greater than the volume of the bulb.

14. The plasma lamp of claim 1, wherein the volume of the dielectric material is greater than five times the volume of the bulb.

15. The plasma lamp of claim 1, wherein the volume of the dielectric material is less than 75 cm³ and the frequency of the RF power is less than 500 MHz.

16. The plasma lamp of claim 1, wherein the volume of the dielectric material is less than 50 cm³ and the frequency of the RF power is less than 500 MHz.

17. The plasma lamp of claim 1, wherein the first and second conductors are provided by a metallic coating on the lamp body.

18. The plasma lamp of claim 1, wherein:
the power source is configured to provide the RF power to the resonant structure at a frequency having a wavelength (λ_{g}) in the resonant structure; and
each of the dimensions across the resonant structure including a height and a width are less than λ_{g}/2.

19. The plasma lamp of claim 1, wherein:
the power source is configured to provide the RF power to the resonant structure at a frequency having a wavelength (λ_{g}) in the resonant structure; and
each of the dimensions across the resonant structure including a height and a width are less than λ_{g}/3.

20. The plasma lamp of claim 1, wherein the relative permittivity greater than 9.

21. The plasma lamp of claim 1, wherein the relative permittivity is between 9 and 15.

22. A method of providing light, the method comprising:
generating radio frequency (RF) power using a power source;
providing a resonant structure having a quarter wave resonant mode, the resonant structure including a lamp body comprising:
a dielectric material having a relative permittivity greater than 2;
an inner conductor; and
an outer conductor;
providing a bulb containing a fill that forms a plasma that emits light; and
coupling the RF power to the resonant structure at about a resonant frequency for the resonant structure to provide the RF power to bulb.

23. An electrodeless plasma lamp comprising:
means for generating radio frequency (RF) power using a power source;
means for providing a resonant structure having a quarter wave resonant mode, the resonant structure including a lamp body comprising:
a dielectric material having a relative permittivity greater than 2;
an inner conductor; and
an outer conductor;
means for providing a bulb containing a fill that forms a plasma that emits light; and
means for coupling the RF power to the resonant structure at about a resonant frequency for the resonant structure to provide the RF power to bulb.
